(19) United States
(12) Patent Application Publication
(10) Pub. No.: US 2021/0158264 A1
(43) Pub. Date: May 27, 2021

(54) AUTOMATED SYSTEM FOR TRACKING PROGRESS OF OPERATIONS DELIVERABLES

(71) Applicant: REV 1 Power Services, Inc., Tampa, FL (US)

(72) Inventors: Richard M. Ehrgott, Tampa, FL (US); Martyn A. Canham, Katy, TX (US); Charles A. Rachel, McKinney, TX (US)

(21) Appl. No.: 16/949,984

(22) Filed: Nov. 23, 2020

Related U.S. Application Data
(60) Provisional application No. 62/939,280, filed on Nov. 22, 2019.

(51) Int. Cl. G06Q 10/06; G06Q 10/10

(52) U.S. Cl. CPC G06Q 10/063114; G06Q 10/103; G06Q 10/0633

(57) ABSTRACT

An automated system performs a method that tracks the progress of milestones, activities and tasks related to facilities readiness leading to safe and efficient start-up and operational readiness of a construction project. Key tasks are automatically identified for each phase of the project and the method ensures consistency and standardization across all projects within an organization. The automated system also provides graphical status updates to identify current progress versus the schedule and identifies any potential issues or late items.

### CROSS-REFERENCE TO RELATED APPLICATIONS

This application claims the benefit of U.S. provisional patent application Ser. No. 62/939,280 filed Nov. 22, 2019.

### FIELD OF THE INVENTION

This invention relates to an automated system for tracking progress of milestones, activities and tasks leading to a safe and efficient start-up and operational readiness of a project.

### BACKGROUND OF THE INVENTION

This section provides background information related to the present disclosure which is not necessarily prior art.

The construction of projects such as power plants, offshore platforms, refineries, and production facilities is an arduous process from a data management and reporting standpoint. It is essential that the activities required to certify the turnover to the owner or operator are tracked and managed extremely closely. If these tasks are not managed meticulously, it will delay the associated activities and subsequent milestones, delaying the overall project resulting in significant losses for both the owner and the constructor. Currently in the industry, constructors predominately utilize spreadsheets to track and manage these tasks. Employees input information on spreadsheets that are saved either in the cloud or on physical computers, creating a significant collaboration challenge. The spreadsheets also cannot house the documents that need to be tracked and evaluated, which is an additional challenge. Progressing the status of these documents is cumbersome and often leads to miscommunications, project delays, and cost overruns.

The database stores these inspection documents in folders for each deliverable and progress is reported for each deliverable based on the percentage of the specific progress for each task.

Thousands of man-hours are spent by the team members preparing the initial hardcopies of vendor documents and owner/operator approval certificates for each deliverable on a typical project. For example, a milestone will be prepared for each major piece of equipment in the facility. The typical milestone can include hundreds of activities, and each activity can have multiple tasks to complete. Team members must keep track of all this information while managing and addressing any issues in project delays. This often results in project slippage, cost overruns, and legal battles due to contract breaches.

Current methods are not capable of tracking the real-time progress of activities, nor do they capture or report real-time listings and status of deliverables for one task or multiple tasks. For facilities readiness systems currently on the market, these efforts are manually typed onto spreadsheet reports and manually updated for action and tracking by others. These existing facilities readiness systems result in time consuming multiple handling of all documents by inspectors, document control personnel and approvers and do not provide real-time tracking of progress, punch list deficiencies and procurement activities.

Existing facilities readiness methods require thousands of man-hours outside of actual project hours to accurately manage the milestones, activities, and tasks for projects. This results in a higher overall cost and increased risk for the companies.

A prior art attempt to automate the commissioning process is described in US Patent Application Publication No. US 2013/0179354 A1, which publication is incorporated herein by reference. The publication discloses an automated system for commissioning verification, progress tracking and punch list resolution of oil and gas production facilities. The system purports to eliminate the need for manual generation of hardcopy inspection reports and engineering documents by providing field inspectors mobile devices for real-time access to the document control system. The system also provides immediate notification to all users when a revised document has been uploaded into the document control system. The system provides automated and real-time progress updates and eliminates delays from manually coding and scanning documents. Punch list deficiencies and corresponding digital images are entered in the field for immediate viewing by onsite and offsite management, engineers and vendors via internet access, allowing for immediate direction or approvals. Material procurement requirements are entered in the field for immediate viewing and action by procurement personnel.

### SUMMARY OF THE INVENTION

The TrackerPlan™ (trademark of Rev1 Power Services, Inc. of Tampa, Fla.) automated system according to the invention is a templated task management process that solves two major issues in project management. Those issues are consistency in the management philosophy and task transparency. Companies that handle a lot of projects per year tend to have a group of project managers that oversee and manage the projects. Those individual project managers have a management style that is unique to them and they apply their methodology to their projects. TrackerPlan™ system applies a layer of consistency to those individual projects by utilizing a consistent template of deliverables. The project managers can still utilize their own management styles they have been accustomed to but now all managers have the same project template to report against.

The second issue is project task visibility. The normal business model for any project is several layers of management that enable a team to work on individual pieces of the project and not get overwhelmed by the sheer volume of tasks that need to be completed. Each level of management needs a different level of information to successfully do their job. By utilizing the TrackerPlan™ system, all levels of management can quickly and easily see the status of a project without attending daily or weekly meetings which consume a lot of time during the week. This recovered time can now be put towards solving other problems and help the project move forward smoothly.

### DESCRIPTION OF THE DRAWINGS

The above as well as other advantages of the present invention will become readily apparent to those skilled in the art from the following detailed description of a preferred embodiment when considered in the light of the accompanying drawings illustrating display screen views generated by the TrackerPlan™ software.

FIG. 1 shows the functional process structure of the automated system invention.

FIG. 2 shows the initial view, where the user must select the project type.

FIG. 3 shows a list of projects (which can be filtered further by asset) and their status.

FIG. 4 shows the overview of the project, including status of each phase, and summary breakdown of task and duration progress.

FIG. 5 shows the select screen; to progress a user must select a Phase.

FIG. 6 shows status of milestones along with the activities and tasks that make up the milestone.

FIG. 7 shows the result of using the “My Tasks” button.

FIG. 8 shows the key fields for a task.

FIG. 9 shows that for each type of project, default milestones, activities and tasks can be created.

FIGS. 10 and 11 show that once the main type is created, recommendations can be edited for each sub type.

FIGS. 12, 13 and 14 depict that the software automatically lists the recommended milestones, activities and tasks for the project type from the predefined customer libraries.

FIG. 15 depicts a highlighted item in bold which identifies to the user that justification is needed for bypassing an activity.

FIG. 16 depicts the step after the explanation is provided in the automated system.

FIG. 17 is a block diagram of the automated system executing the software program according to the invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention and are not intended to limit the scope of the invention in any manner. In respect of the methods disclosed, the steps presented are exemplary in nature, and thus, the order of the steps is not necessary or critical.

TEMPLATES—The definition phase should be captured in a separate document and compiled together with other similar documents if the scope of work requires more than one software component to build.

DASHBOARD—A meeting with the developer(s), QA (question and answer), client representative (if applicable) should be held to align the group on the process and make any adjustments to the scoped requirements. Signed scope of work document from client accepting the work scope and requirements.

OVERVIEW—The requirements should be migrated to the version control software and a points system applied and a timeline of completion generated. A developer can be assigned at this time.

TASK MANAGER—The developers will update the progress in the version control software and flag any problem items so they can be discussed during the progress review sessions. If during the course of the development the scope of work changes, then the developer will update the version control software with the changes and assign new points and a revised timeline of completion.

CORPORATE INTEGRATION—The developer should publish their work to their test environment and verify the component meets the required specs. Once satisfied with the component then it should be released to the QA/Testing group for final acceptance.

TRAINING—Prior to final release to the client, training material must be generated and delivered to the client or made available through the software. A notice of the update must be provided to the client in the appropriate manner and then the software product can be released for use.

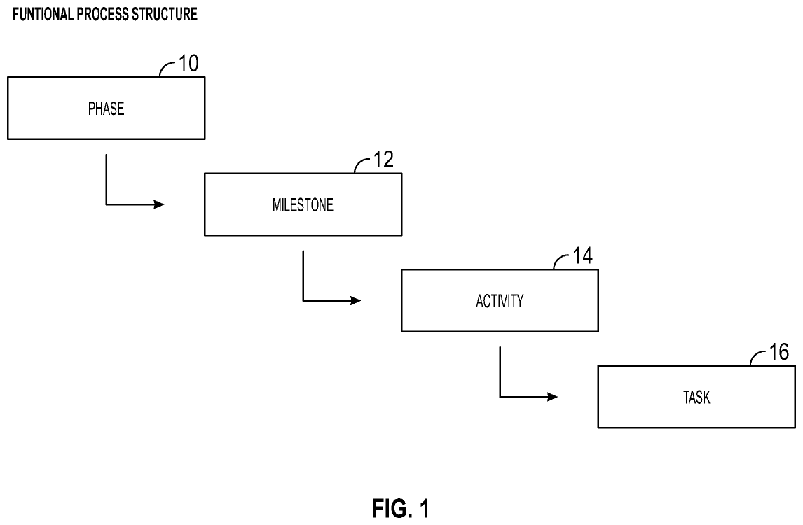

The Functional Process Structure of the invention is shown in FIG. 1. This process is the basis for the facilities readiness software technology. Each project progresses based upon the four pillars: Phase 10, Milestone 12, Activity 14 and Task 16. Each Phase can be configured for the user, but may have one or more Milestones. Each Milestone has one or more Activities. Each Activity has one or more Tasks. This structure represents the process on which the inventive automated system technology is founded.

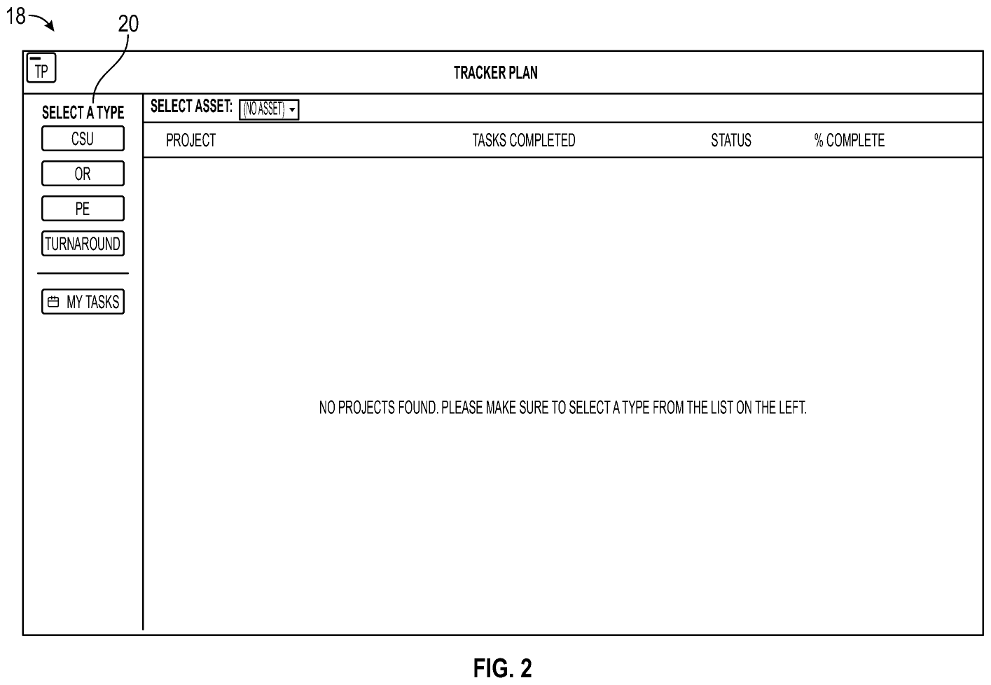

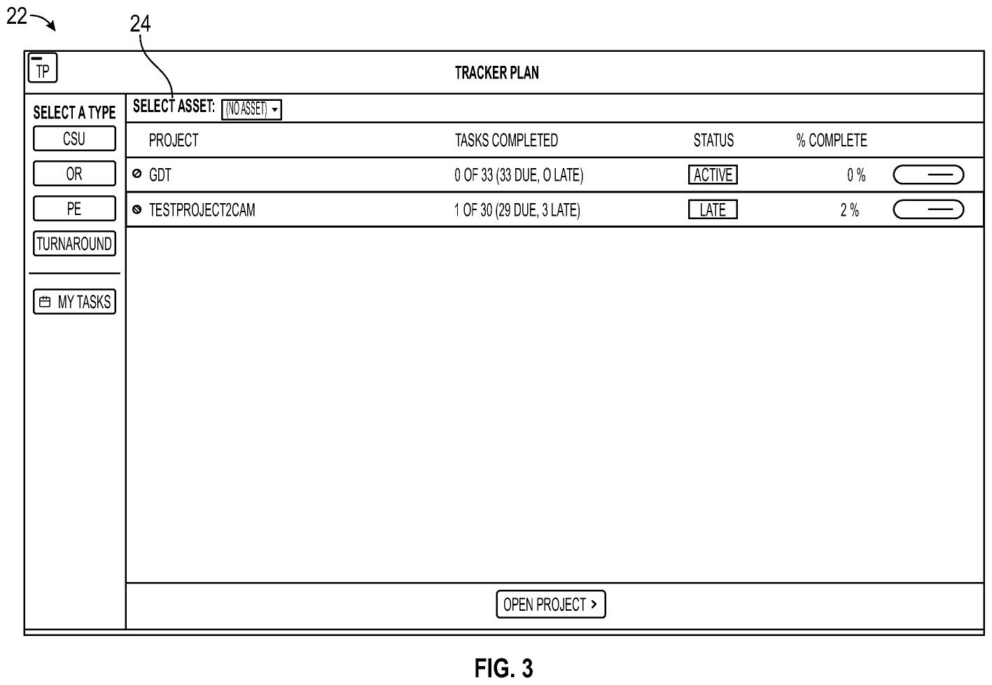

Element 1: Process for reviewing project status/overview. FIG. 2 shows the initial screen view 18, where the user must select 20 the project type. This screen view and the screen views depicted In FIGS. 3 through 16 are generated by the automated system on a suitable display monitor.

FIG. 3 is a screen view 22 of a list of projects (which can be filtered further by asset 24) and their status.

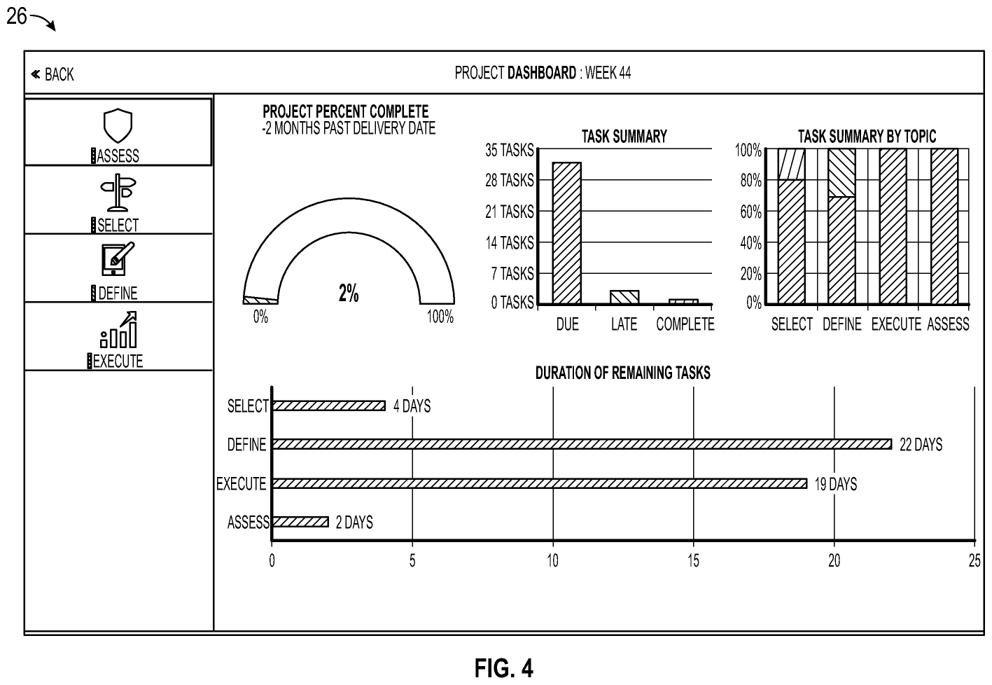

FIG. 4 (Project Dashboard) is a screen view 26 that shows an overview of the project, including the status of each Phase, and a summary breakdown of Task and duration progress.

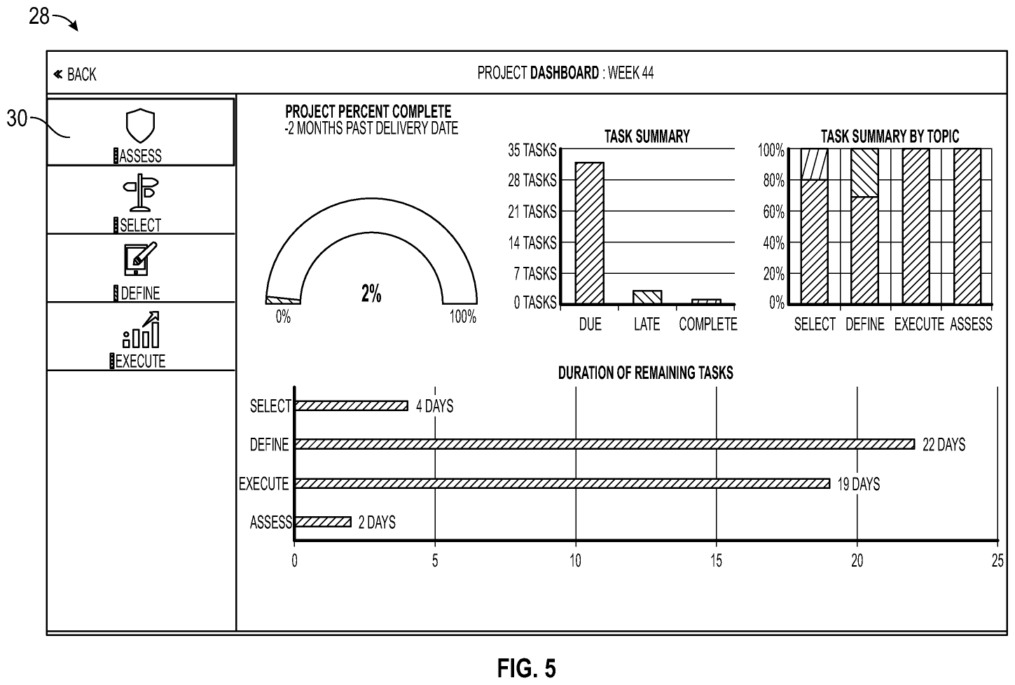

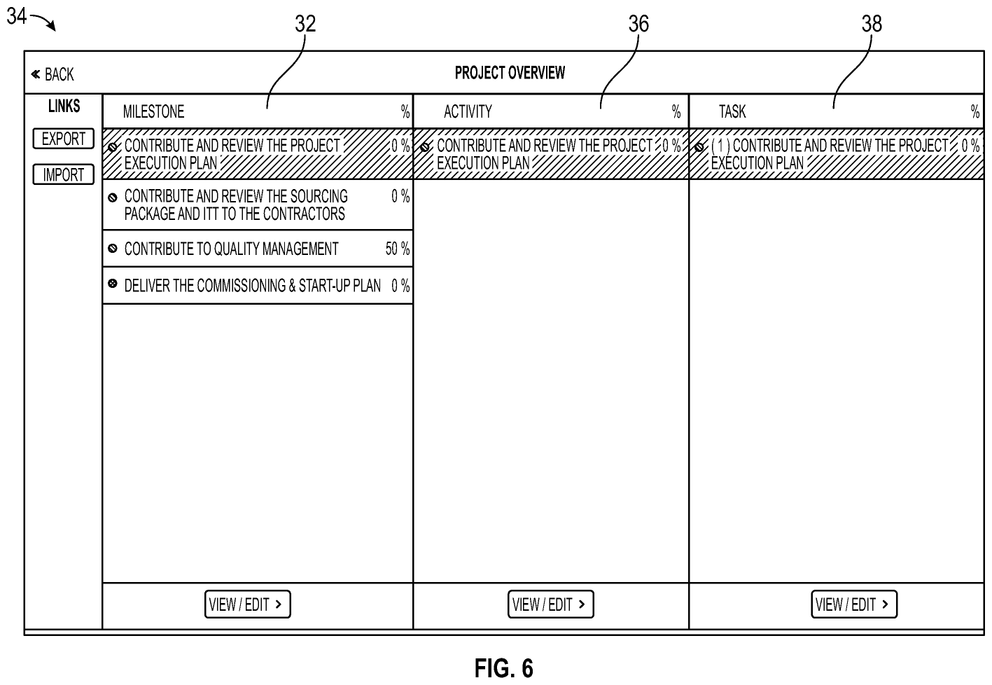

Element 2: Process for Identifying progress of Milestones, Activities, Tasks. FIG. 5 (Project Dashboard) is a screen view 28 that shows the select screen; to progress a user must select 30 a Phase. The status of the Milestones 32 is shown in the FIG. 6 (Project Overview) screen view 34, along with the Activities 36 and the Tasks 38 that make up the Milestone. Click on different ones of the Milestones 32 to see breakdown of the related Activities 36 and Tasks 38. Color coding can be used to shows Late, Nearly Due, and OK status of the Tasks. This status coding is automatically used to calculate the status of other items—once a Task is late, it will be color coded as Late on the applicable Activity, Milestone, and Phase as well.

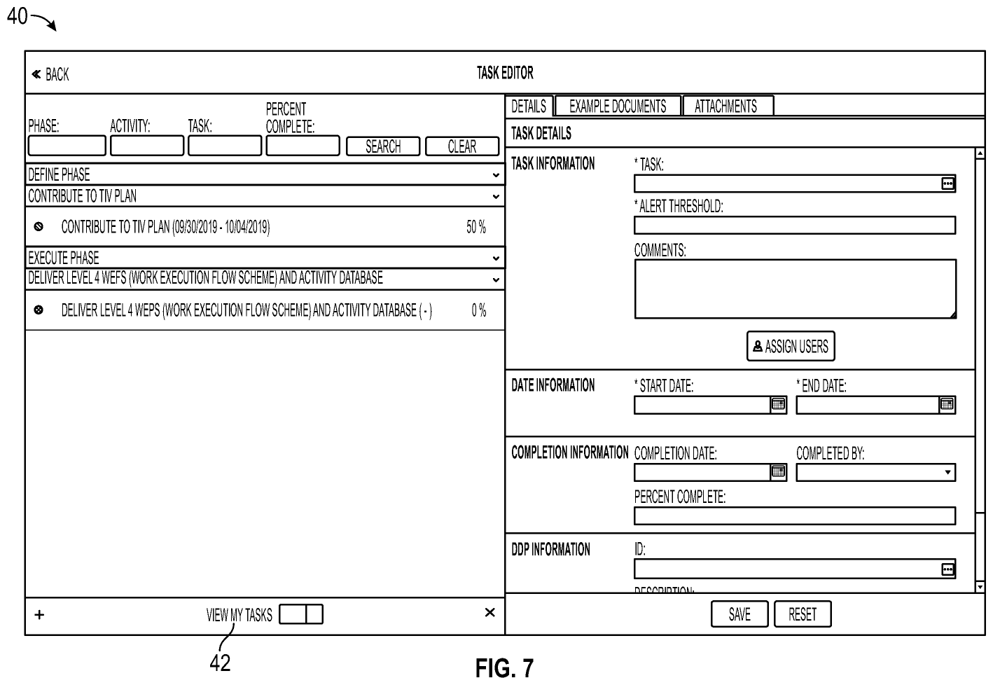

Element 3: Process to locate Tasks assigned to the logged in user. FIG. 7 (Task Editor) is a screen view 40 that shows the result of using the “View My Tasks” button 42, which quickly filters the list of Tasks to only show those which require input from the logged in user.

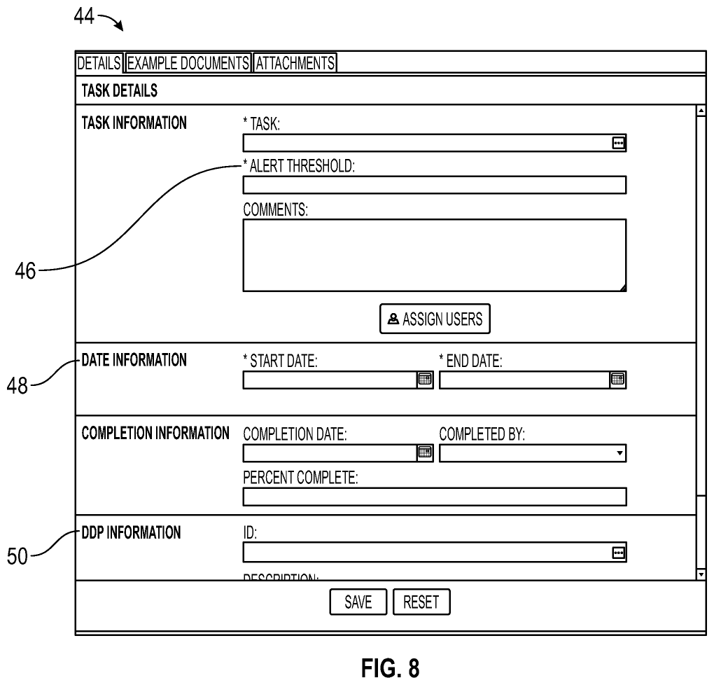

Element 4: Process for updating a task. FIG. 8 (Task Details) is a screen view 44 that shows the key fields for a Task. This activity is the basis for tracking of progress of the project and includes fields such as: Alert Threshold 46 to determine when to flag items as “nearly due”. Date Information 48 including Start Date and End Date for scheduling and

calculating duration percent complete for tracking progress. DDP Information 50 links to company specific procedures.

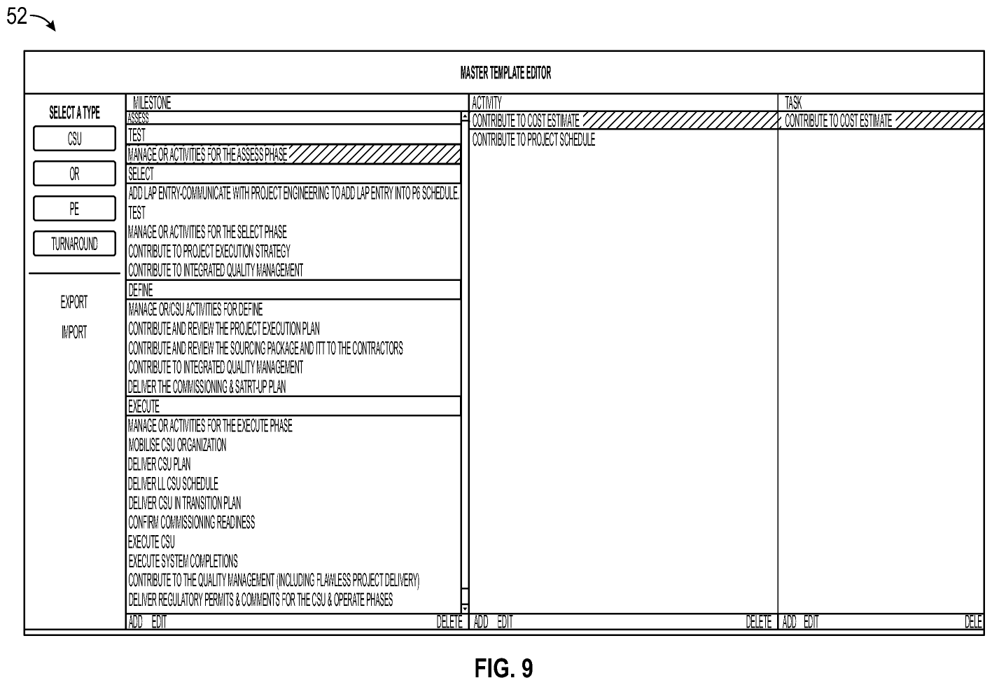

Element 5: Process to set up master templates and recommendations for different project types. FIG. 9 (Master Template Editor) is a screen view 52 that shows that for each type of project, default Milestones, Activities and Tasks can be created.

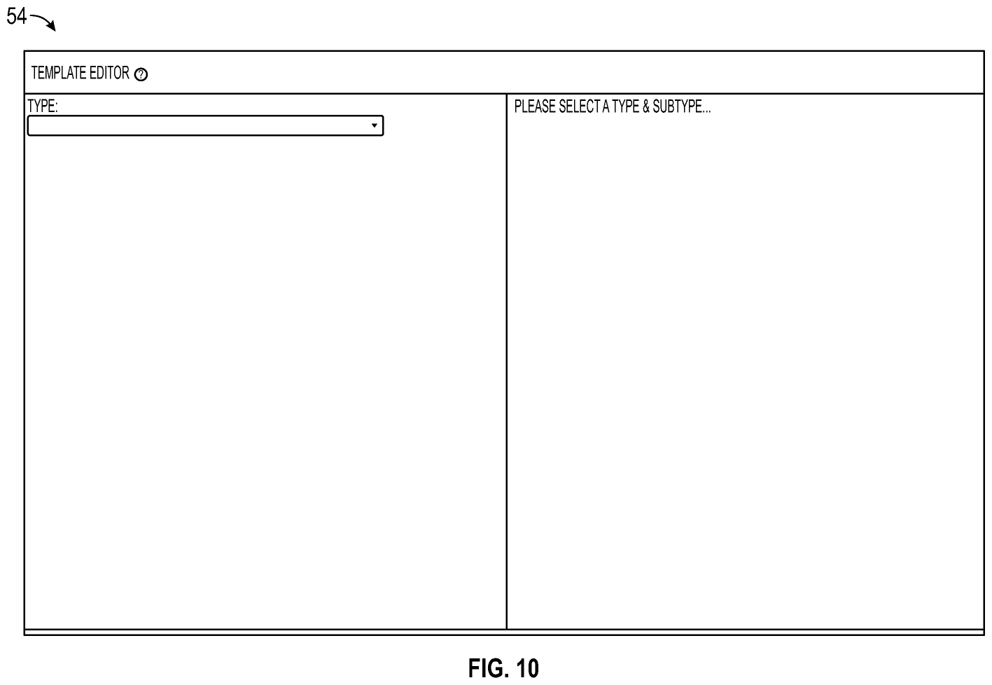

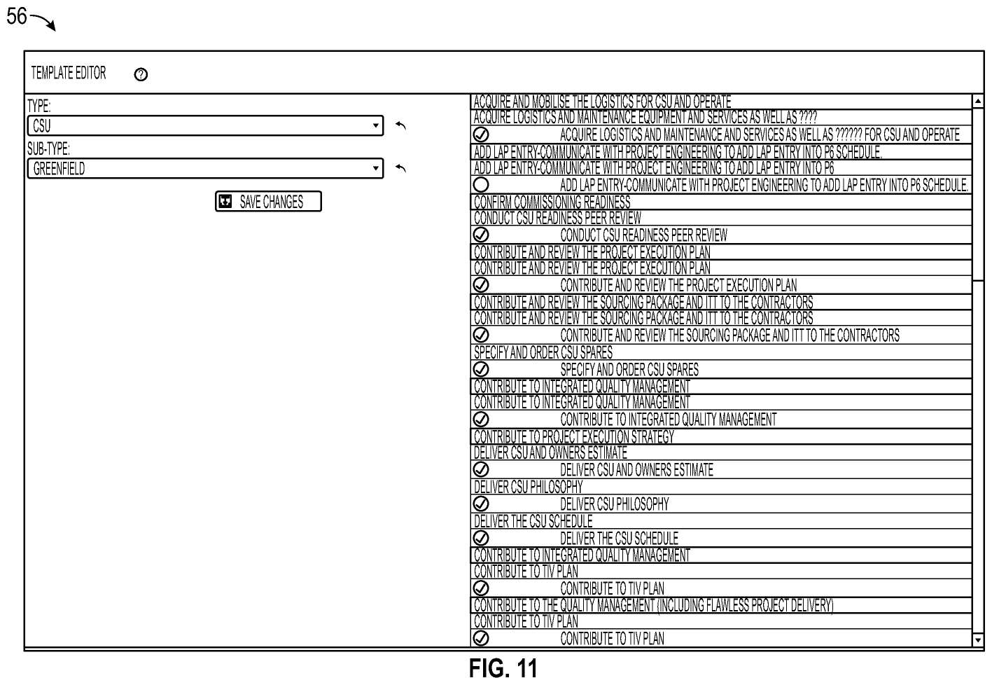

FIGS. 10 and 11 (Template Editor) are screen views 54 and 56 that show that once the main Type is created in FIG. 10, recommendations can be edited in FIG. 11 for each Sub Type (i.e. Greenfield/Brownfield).

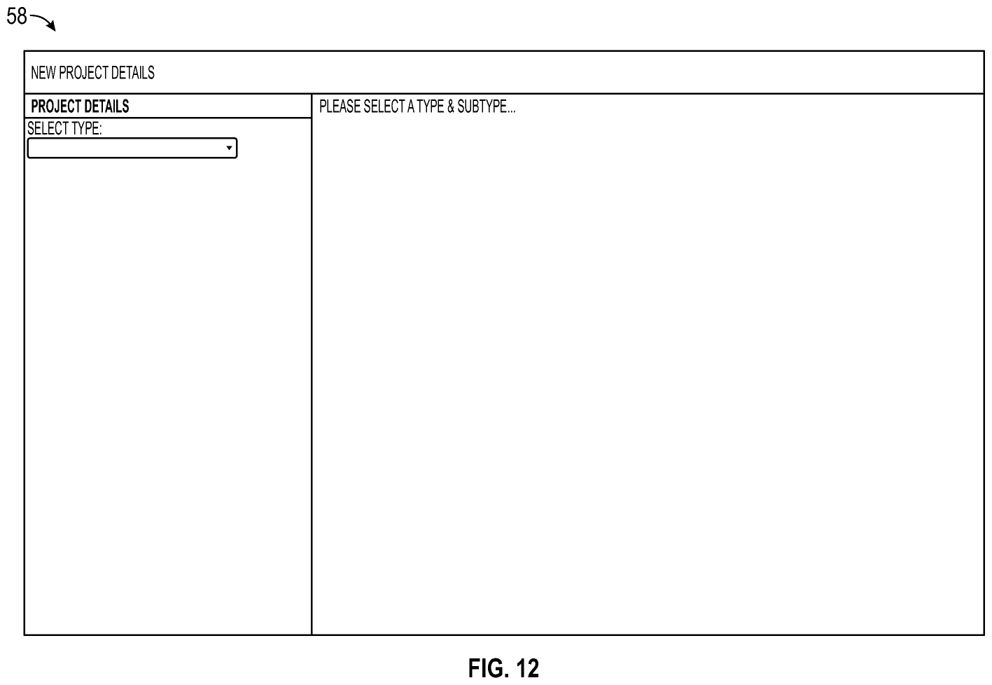

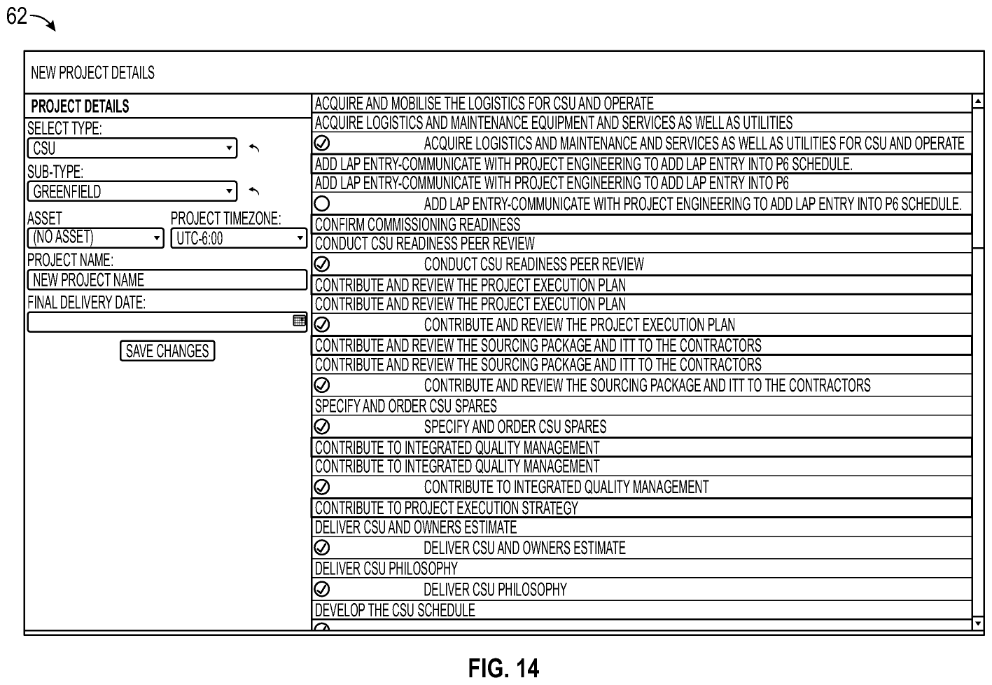

Element 6: Process to auto-populate Tasks for a new project. FIGS. 12, 13 and 14 (New Project Details) are screen views 58, 60 and 62 that depict that the automated system software automatically lists the recommended Milestones, Activities and Tasks for the project type from information stored in predefined customer libraries. The software then allows these to be reviewed for the specific project prior to project creation and prompts the user to fill in all pertinent project details. Where required, the software also enforces a review step prior to a project going live. In this review step, the software prompts users by highlighting deviations from the company standards and ensuring justifications are included for such deviation. FIG. 14 depicts the predefined milestones that the software automatically selects based on the prior project type selection.

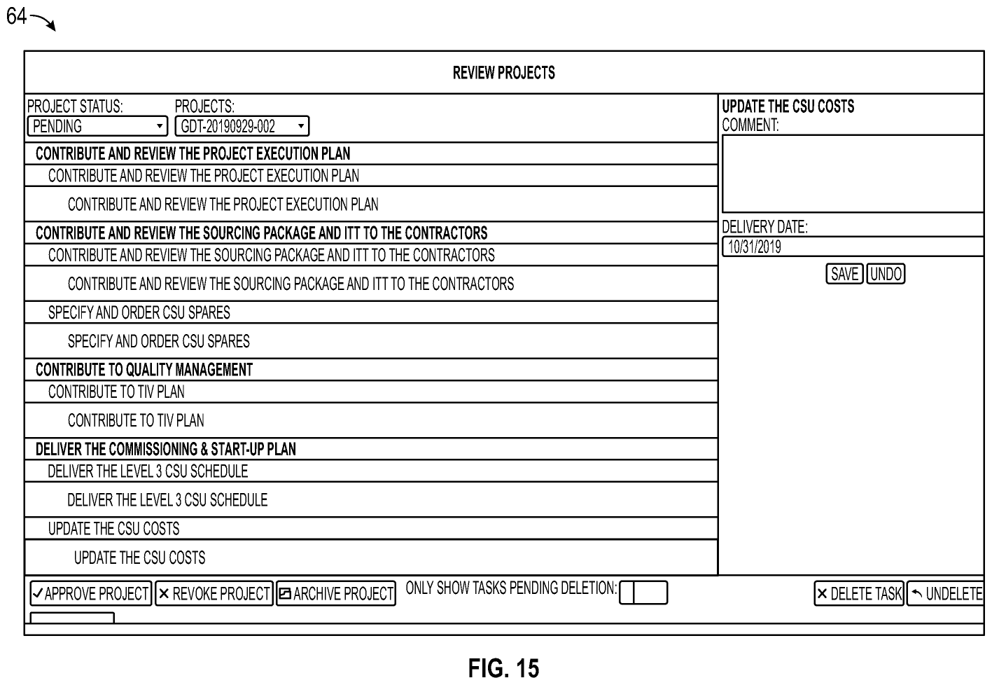

Element 7: Process for identifying a deviation from the corporate mandated Milestone selection. FIG. 15 (Review Projects) is a screen view 64 that depicts a highlighted item in bold which identifies to the user that justification is needed for bypassing an Activity.

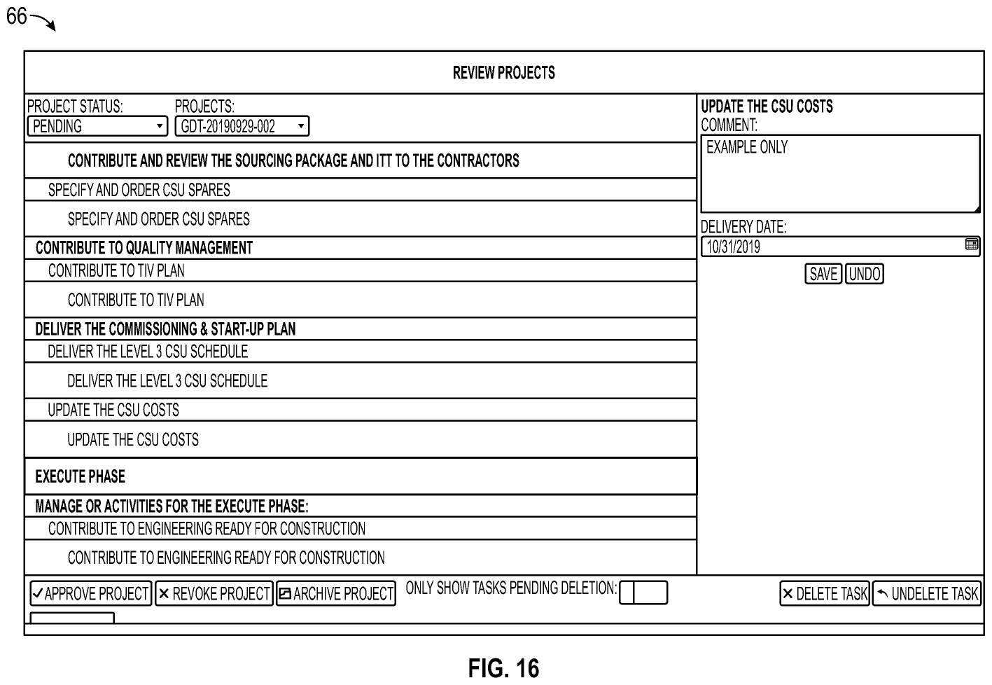

FIG. 16 (Review Projects) is a screen view 66 that depicts the step after the explanation is provided in the automated system. It allows the user to continue forward with submission of the new project which will then go through the review process at the manager level. Once the manager has approved the project, the user is free to begin executing work for the project. Conversely, if the project is rejected, the user will need to add the Activity back in or provide further justification for the removal of that Activity.

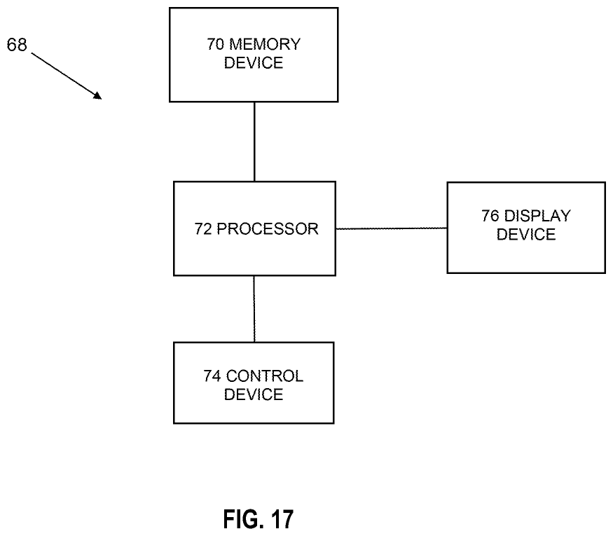

FIG. 17 is a block diagram of a computer system 68 for performing the method according to the invention. A computer program, including instructions for performing the method, is stored in a non-transitory computer-readable medium such as a memory device 70. The memory device 70 is communicates with a processor 72 that reads and executes the instructions to perform the method. The processor 72 receives inputs and data from at least one user operated control device 74 (e.g., a computer terminal or a smartphone) and generates the screen views shown in FIGS. 2 through 16 to at least one user display device 76. The connections for communication between the devices of the computer system 68 can be hard-wired, wireless or a combination thereof. Thus, any of the devices of the computer system 68 can be located remote from any other of the devices. However, the user can access one of the control devices 74 and one of the display devices 76 located together. In some case, the control device 74 can be a touch sensitive screen display of the display device 76.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE NUMERALS

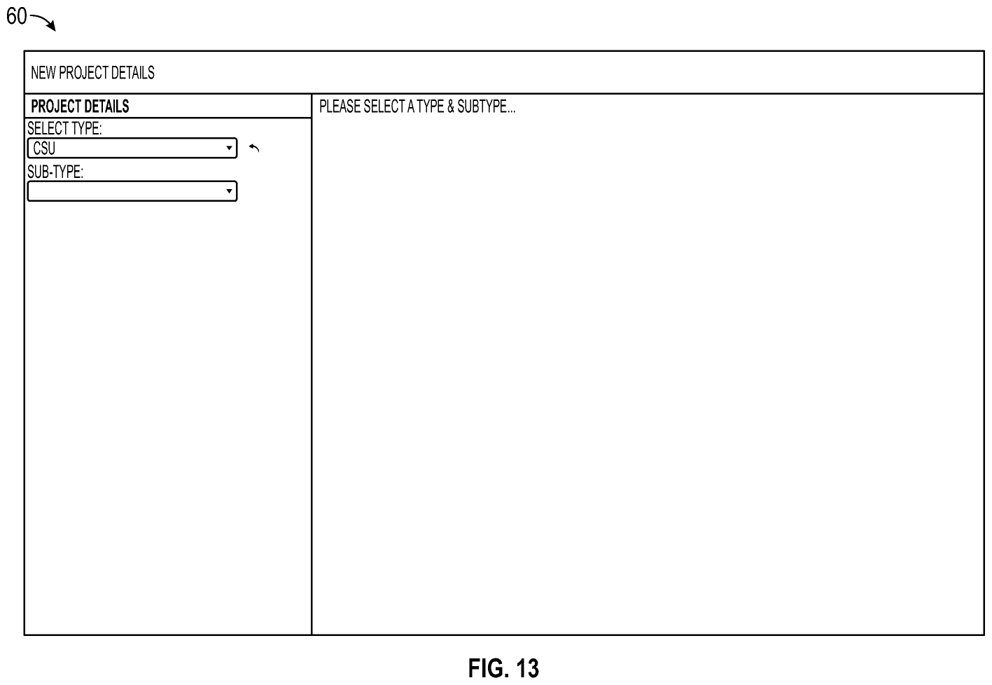

10 Phase
12 Milestone
14 Activity
16 Task
18 FIG. 2 screen view
20 select project type
22 FIG. 3 screen view
24 asset
26 FIG. 4 (Project Dashboard) screen view
28 FIG. 5 (Project Dashboard) screen view
30 select Phase
32 Milestones status
34 FIG. 6 (Project Overview) screen view
36 Activities
38 Tasks
40 FIG. 7 (Task Editor) screen view
42 “View My Tasks” button
44 FIG. 8 (Task Details) screen view
46 Alert Threshold
48 Date Information
50 DDP Information
52 FIG. 9 (Master Template Editor) screen view
54 FIG. 10 (Template Editor) screen view
56 FIG. 11 (Template Editor) screen view
58 FIG. 12 (New Project Details) screen view
60 FIG. 13 (New Project Details) screen view
62 FIG. 14 (New Project Details) screen view
64 FIG. 15 (Review Projects) screen view
66 FIG. 16 (Review Projects) screen view
68 computer system
70 memory device
72 processor
74 control device
76 display device

What is claimed is:

1. A method tracking a progress of commissioning services to determine a facilities readiness of a project using an automated system including a processor for executing computer program instructions, the method comprising the steps of:
storing a plurality of project types and associated projects in a memory device;
operating a processor to execute computer program instructions to read the project types from the memory device and generate a list of the project types as a first screen view on a display device;
inputting a selected one of the project types to the processor with a control device, the processor responding to the selected project type by generating a list of the projects associated with the selected project type as a second screen view on the display device; and
inputting a selected one of the displayed projects to the processor with the control device, the processor responding to the selected project by generating a project dashboard associated with the selected project as a third screen view on the display device.

2. The method according to claim 1 wherein the third screen view is an overview of the selected project including a status of each phase of the selected project.

3. The method according to claim 2 wherein the overview displayed in the third screen view includes a summary breakdown of a progress of associated tasks by topic and by duration.

4. The method according to claim 2 wherein the third screen view includes an area to select one of the phases wherein the processor responds to the selected phase by generating a fourth screen view showing milestones associated with the selected phase.

5. The method according to claim 4 including selecting one of the milestones to display related activities and tasks with a status of the tasks.

6. The method according to claim 5 including activating a View My Tasks button displayed in the fourth screen view wherein the tasks are filtered to show only ones of the tasks that require input from an associated user logged into the automated system.

7. The method according to claim 5 including selecting one of the tasks wherein the processor responds to the selected task by generating a display of key fields as a fifth screen view for updating the task.

8. The method according to claim 7 wherein the key fields include:
an Alert Threshold field to determine when to flag the task as “nearly due”;
a Start Date field and an End date field for scheduling and calculating task duration;
a Percent Complete field for tracking progress of the task; and
a DDP Information field that links to company specific procedures related to the task.

9. The method according to claim 1 wherein the processor generates a master template editor screen on the display device enabling a user to perform a setup of master templates for the project types and generate recommendations for the ones of the project types to be stored.

10. The method according to claim 1 wherein the processor automatically lists recommended milestones, activities and tasks for each of the stored project types based upon information from predetermined customer libraries stored in the memory device.

11. The method according to claim 10 wherein the processor performs a review of the milestones, the activities and the tasks for the selected project to identify any deviation from the predetermined customer library information associated with the selected project and displays any identified deviation on the display device for justification of the identified deviation by the user.

12. An automated system for tracking a progress of commissioning services to determine a facilities readiness of a project, the automated system comprising:
a memory device storing a plurality of project types and associated projects;
a display device;
a control device;
a processor in communication with the memory device, the display device and the control device;
a non-transitory computer-readable medium including instructions stored thereon for tracking a progress of commissioning services to determine a facilities readiness; and
where the processor executes the instructions to,
to read the project types from the memory device and generate a list of the project types as a first screen view on the display device,
respond to a selected one of the project types inputted from the control device to generate a list of the projects associated with the selected project type as a second screen view on the display device, and
respond to a selected one of the displayed projects inputted from the control device to generate a project dashboard associated with the selected project as a third screen view on the display device.

13. The automated system according to claim 12 wherein the third screen view is an overview of the selected project including a status of each phase of the selected project and includes a summary breakdown of a progress of associated tasks by topic and by duration.

14. The automated system according to claim 13 wherein the third screen view includes an area to select one of the phases with the control device wherein the processor responds to the selected phase by generating a fourth screen view showing milestones associated with the selected phase.

15. The automated system according to claim 14 in response to selecting one of the milestones with the control device, the processor generates a display of related activities and tasks with a status of the tasks on the display device.

16. The automated system according to claim 15 including activating a View My Tasks button displayed in the fourth screen view with the control device wherein the processor filters the tasks to show only ones of the tasks that require input from an associated user logged into the automated system.

17. The automated system according to claim 15 including selecting one of the tasks with the control device wherein the processor responds to the selected task by generating a display of key fields as a fifth screen view for updating the task and wherein the key fields include:
an Alert Threshold field to determine when to flag the task as “nearly due”;
a Start Date field and an End date field for scheduling and calculating task duration;
a Percent Complete field for tracking progress of the task; and
a DDP Information field that links to company specific procedures related to the task.

18. The automated system according to claim 12 wherein the processor generates a master template editor screen on the display device enabling a user to perform a setup of master templates for the project types and generate recommendations for the ones of the project types to be stored using the control device.

19. The automated system according to claim 12 wherein the processor automatically lists recommended milestones, activities and tasks for each of the stored project types based upon information from predetermined customer libraries stored in the memory device.

20. The automated system according to claim 19 wherein the processor performs a review of the milestones, the activities and the tasks for the selected project to identify any deviation from the predetermined customer library information associated with the selected project and displays any identified deviation on the display device for justification of the identified deviation by the user.
